(19) United States
(12) Patent Application Publication
(10) Pub. No.: US 2026/0109288 A1
(43) Pub. Date: Apr. 23, 2026

(54) BEAM CONTROL METHOD AND APPARATUS

(71) Applicant: Wistron Corp., New Taipei City (TW)

(72) Inventors: Li Wei CHEN, New Taipei City (TW); Hsiu Mei LIN, New Taipei City (TW); Hui Chen LIN, New Taipei City (TW); Ming Chiuan JING, New Taipei City (TW)

(21) Appl. No.: 19/002,030

(22) Filed: Dec. 26, 2024

(30) Foreign Application Priority Data
Oct. 22, 2024 (TW) 113140058

(51) Int. Cl. B60Q 1/08; B60W 50/14; G06V 10/25; G06V 20/58

(52) U.S. Cl. CPC B60Q 1/085; B60W 50/14; G06V 10/25; G06V 20/58

(57) ABSTRACT

A beam control method is provided in the invention. The beam control method may be applied to a beam control apparatus configured in a car. The beam control method may include the following steps. The beam control apparatus obtains an image. An advanced driver assistance system (ADAS) of the beam control apparatus may determine whether at least one pedestrian is detected in front of the car according to the image. When the ADAS detects at least one pedestrian in front of the car, a beam control device may obtain pedestrian information of the at least one pedestrian and speed information of the car, and determine whether to enable a polite mode according to the pedestrian information and the speed information. When the beam control device enables the polite mode, the beam control device may control the display pattern of the beam device according to the pedestrian information.

### CROSS REFERENCE TO RELATED APPLICATIONS

This application claims priority of TW patent application No. 113140058 filed on Oct. 22, 2024, the entirety of which is incorporated by reference herein.

### BACKGROUND OF THE INVENTION

### Field of the Invention

The invention generally relates to beam control technology, and more particularly, it relates to beam control technology in which the display pattern of beams is controlled according to pedestrian information.

### Description of the Related Art

In order to increase road safety, the pedestrian-detection technology used in cars has become important. For example, an advanced driver assistance system (ADAS) may be configured in a car for the detection of pedestrians. In addition, as in-vehicle applications continue to progress, the applications for smart beams (e.g., an adaptive driving beam (ADB)) have become more and more widespread.

Therefore, how to combine pedestrian-detection technology with smart beam technology to help drivers quickly and reliably notice the presence of pedestrians ahead, and to make pedestrians more clearly visible to said drivers to reduce traffic accidents is a subject that is worthy of discussion.

### BRIEF SUMMARY OF THE INVENTION

A beam control method and apparatus are provided to overcome the problems mentioned above.

An embodiment of the invention provides a beam control method. The beam control method may be applied to a beam control apparatus configured in a car. The beam control method may comprise the following steps. The beam control apparatus may be configured to obtain an image. An advanced driver assistance system (ADAS) of the beam control apparatus may be configured to determine whether at least one pedestrian is detected in front of the car according to the image. When the ADAS detects at least one pedestrian in front of the car, a beam control device of the beam control apparatus may be configured to obtain pedestrian information of the at least one pedestrian and speed information of the car, and determine whether to enable a polite mode according to the pedestrian information and the speed information. When the beam control device enables the polite mode, the beam control device may be configured to control a display pattern of a beam device of the beam control apparatus according to the pedestrian information.

An embodiment of the invention provides a beam control apparatus. The beam control may comprise a photographing device, an ADAS, a beam control device, and a beam device. The photographing device may obtain an image. The ADAS may determine whether at least one pedestrian is detected in front of the car according to the image. The beam control device may obtain pedestrian information of the at least one pedestrian, and the speed information of the car when the ADAS detects at least one pedestrian in front of the car, and determine whether to enable a polite mode according to the pedestrian information and the speed information. The beam device may be coupled to the beam control device. When the beam control device enables the polite mode, the beam control device may control a display pattern of the beam device according to the pedestrian information.

Other aspects and features of the invention will become apparent to those with ordinary skill in the art upon review of the following descriptions of specific embodiments of a beam control method and apparatus.

### BRIEF DESCRIPTION OF THE DRAWINGS

The invention will become more fully understood by referring to the following detailed description with reference to the accompanying drawings, wherein:

FIG. 1 is a block diagram of a beam control apparatus 100 according to an embodiment of the invention;

FIG. 2 is a flow chart 200 illustrating an example scenario of entering the polite mode according to an embodiment of the invention;

FIG. 3 is a flow chart 300 illustrating an example scenario of determining whether to enter the polite mode according to an embodiment of the invention;

FIG. 4 is a schematic diagram of a specific area according to an embodiment of the invention;

FIG. 5 is a schematic diagram of region of interest (ROI) information corresponding to a pedestrian according to an embodiment of the invention;

FIG. 6 is a flow chart 600 illustrating an example scenario of determining whether to leave from the polite mode according to an embodiment of the invention;

FIG. 7 is a flow chart 700 illustrating an example scenario of the polite mode according to an embodiment of the invention;

FIGS. 8A-8B show a schematic diagram of a ripple light pattern according to an embodiment of the invention; and

FIG. 9 is a flow chart 900 illustrating a beam control method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

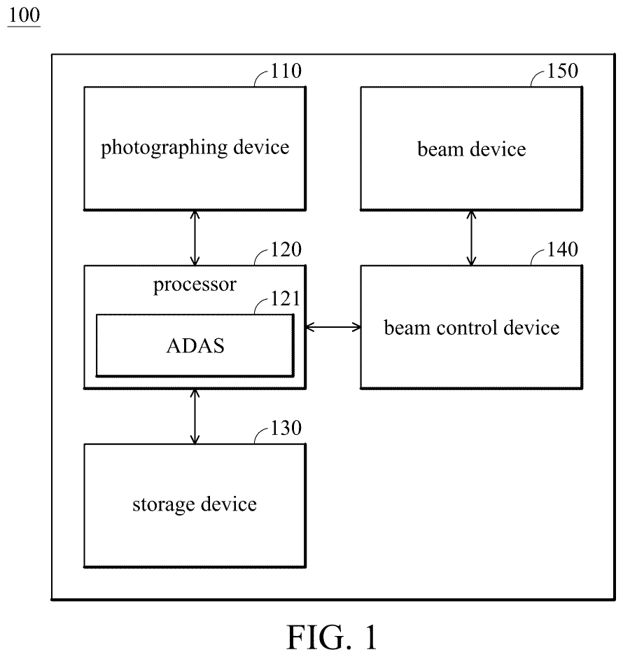

FIG. 1 is a block diagram of a beam control apparatus 100 according to an embodiment of the invention. The beam control apparatus 100 may be configured in a car. As shown in FIG. 1, the beam control apparatus 100 may comprise a photographing device 110, a processor 120, a storage device 130, a beam control device 140 and a beam device 150. It should be noted that FIG. 1 presents a simplified block diagram in which only the elements relevant to the invention are shown. However, the invention should not be limited to what is shown in FIG. 1. The beam control apparatus 100 may also comprise other elements.

According to an embodiment of the invention, the photographing device 110 may be an electronic device with the photography function, e.g., a camera. The photographing device 110 may be used to photo the image of the front of the car.

According to an embodiment of the invention, the processor 120 may be a chip or a processor which can perform the high performance computing (HPC). In addition, the processor may be used to control the operations of an advanced driver assistance system (ADAS) 121.

According to an embodiment of the invention, the storage device 130 may store the software and firmware program codes, system data, user data, etc. of the beam control apparatus 100. The storage device 130 may be a volatile memory (e.g. Random Access Memory (RAM)), or a non-volatile memory (e.g. flash memory, Read Only Memory (ROM)), a hard disk, or a combination of the above memory devices.

According to an embodiment of the invention, the beam control device 140 may comprise at least one electronic control unit (ECU). According to the embodiments of the invention, each ECU of the beam control device 140 may obtain the information (e.g., pedestrian information, speed information of the car, driving related information, and so on) from the ADAS 121 through a controller area network bus (CAN BUS), and control the beam device 150 according to the information obtained from the ADAS 121. In addition, a zonal control unit (ZCU) may be configured between the processor 120 and the beam control device 140 to transmit the information obtained from the ADAS 121 to each ECU of the beam control device 140. The processor 120 and the beam control device 140 may also transmit information or signals to the ZCU through the CAN BUS.

According to an embodiment of the invention, the beam device 150 may comprise a plurality of beams, e.g., left beam and right beam. Each beam may be corresponded to an ECU. In an embodiment, each beam may comprise a low beam, a high beam, or a matrix beam. Each beam of the beam device 150 may display different display patterns according to the indication from the ECU.

According to an embodiment of the invention, the ADAS 121 may determine whether detecting at least one pedestrian in front of the car according to the image obtained by the photographing device 110. When the ADAS 121 detects that there is at least one pedestrian in front of the car, the beam control device 140 may obtain the pedestrian information and the speed information of the car from the ADAS 121 first, and then determine whether to enable a polite mode according to the pedestrian information and the speed information corresponding to the car. When the beam control device 140 determines that the polite mode needs to be enabled, the beam control device 140 may control the display pattern (e.g., display a ripple light pattern) of the beam device 150 according to the pedestrian information. In addition, when the polite mode is enabled, the beam control device 140 may determine to continue the polite mode or close the polite mode according to the following information (e.g., the pedestrian information or the speed information) from the ADAS 121. Details will be illustrated below by referring to the figures.

It should be noted that the polite mode in the invention is an optimization method for the pedestrian detection. The polite mode is applied when the ADAS 121 determine that there is pedestrian in front of the car to increase the pedestrian and deriver safety. Detail operations of the polite mode will be illustrated in the below embodiments and figures.

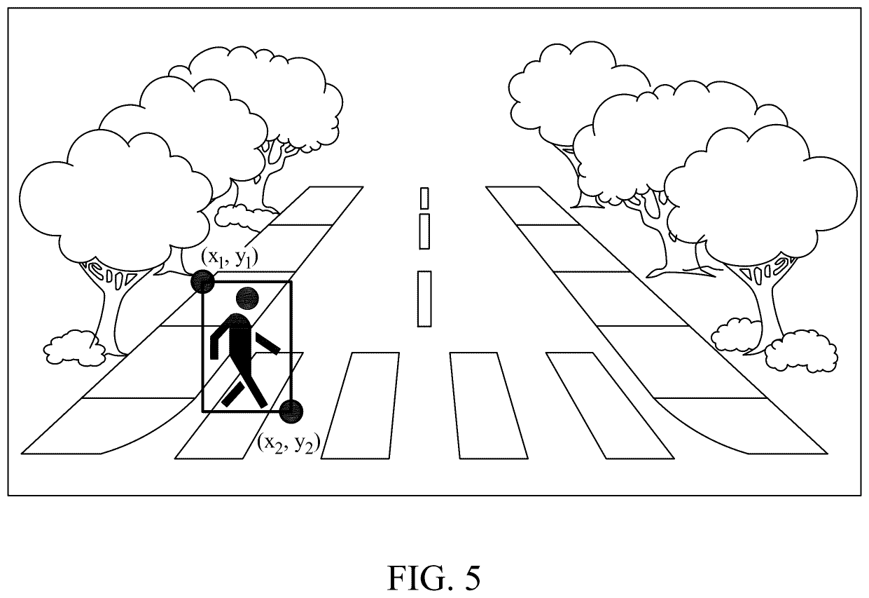

According to an embodiment of the invention, when ADAS 121 detects that there is a pedestrian in front of the car, the ADAS 121 may generate the pedestrian information corresponding to the pedestrian. According to an embodiment of the invention, the pedestrian information may comprise the region of interest (ROI) information corresponding to each pedestrian, e.g., the ROI coordinates corresponding to each pedestrian (as shown in FIG. 5). In an embodiment, in the polite mode, the beam control device 140 may group multiple ROI information with similar locations to generate the ROI coordinates corresponding to a group of pedestrians. In another embodiment, in the polite mode, the beam control device 140 may perform a priority value sorting according to the ROI information of each pedestrian. For example, the beam control device 140 may know the relative position and relative distance between the car and each pedestrian (or each pedestrian group) according to the ROI information of each pedestrian (or each pedestrian group), and then the beam control device 140 may perform a priority value sorting according to the relative position and relative distance between the car and each pedestrian (or each pedestrian group). Details for the calculations related to the ROI coordinates are discussed below.

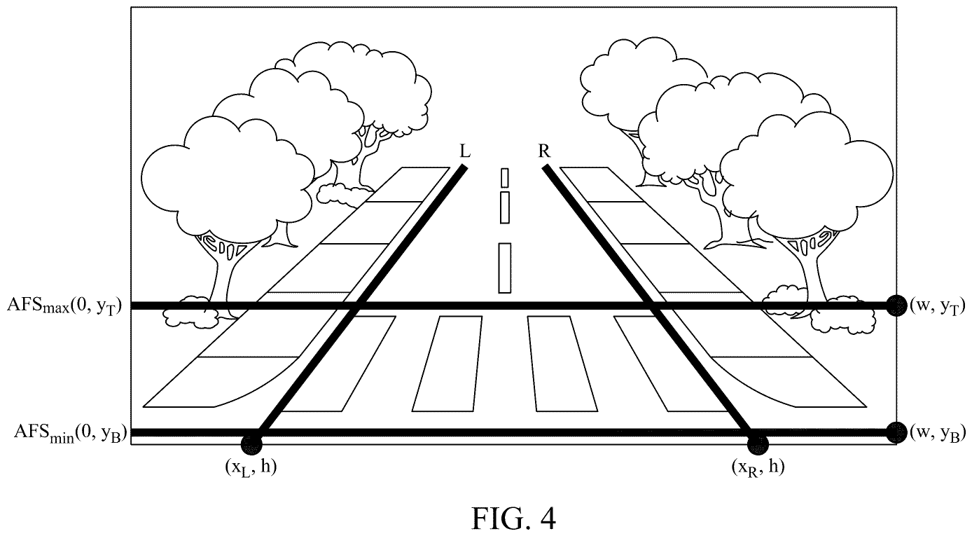

According to an embodiment of the invention, the beam control device 140 may determine whether a enable condition is met according to the pedestrian information and the speed information of the car to determine whether enable a polite mode. In an embodiment, an enable condition may comprise that the pedestrian is in a specific area, the speed of the car is slower than the default value, and the distance between the car and the pedestrian is shorter than the default distance value, but the invention should not be limited thereto. According to an embodiment of the invention, the specific area (as shown in FIG. 4) may be defined based on the left boundary, the right boundary, and the longest illumination distance of the front light of the car (e.g., the longest illumination distance of the adaptive front-lighting system (AFS) of the car).

According to an embodiment of the invention, in the polite mode, the beam control device 140 may determine whether to stop the polite mode according to a stop condition. According to an embodiment of the invention, the stop condition may comprise that no people are detected in a frame of image, the gear of the car is not in drive (D) gear, the speed of the car is faster than the default value, and so on.

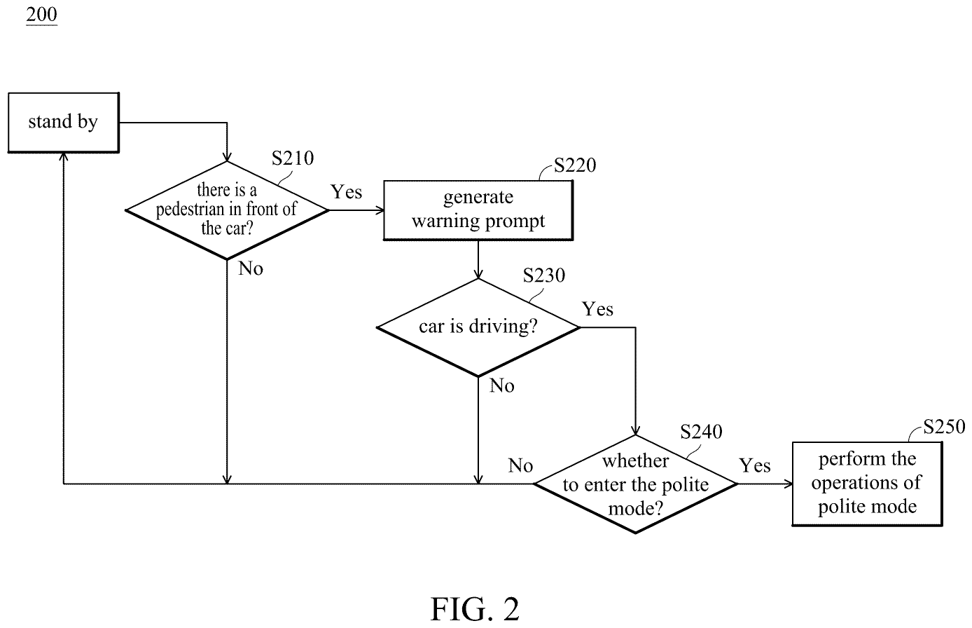

FIG. 2 is a flow chart 200 illustrating an example scenario of entering the polite mode according to an embodiment of the invention. The flow chart 200 can be applied to the beam control apparatus 100 configured in a car. As shown in FIG. 2, in step S210, when the beam control apparatus 100 is in a standby state, the ADAS 121 may determine whether detecting at least one pedestrian in front of the car according to the image obtained by the photographing device 110.

When the ADAS 121 determines that there is a pedestrian in front of the car, step S220 is performed. In step S220, the beam control apparatus 100 may generate a warning prompt, e.g., generate an alarm sound or display a warning image. When the ADAS 121 determines that there is no pedestrian in front of the car, the beam control apparatus 100 remain in the standby state.

In step S230, the beam control apparatus 100 may determining whether the car is running. If the car is not running, the beam control apparatus 100 remain in the standby state.

If the car is running, step S240 is performed. In step S240, the beam control device 140 of the beam control apparatus 100 may determine whether to enter the polite mode. When the beam control device 140 of the beam control apparatus 100 determines to enter the polite mode, step S250 is performed. In step S250, the beam control apparatus 100 may perform the operations of the polite mode. In addition, in step S240, the beam control apparatus 100 may further determine whether the polite mode function is enabled. In an embodiment, the user can set to enable or disable the polite mode function on the display interface of the beam control apparatus 100. In another embodiment, the beam control apparatus 100 may automatically enable the polite mode function to determine whether to enter the polite mode.

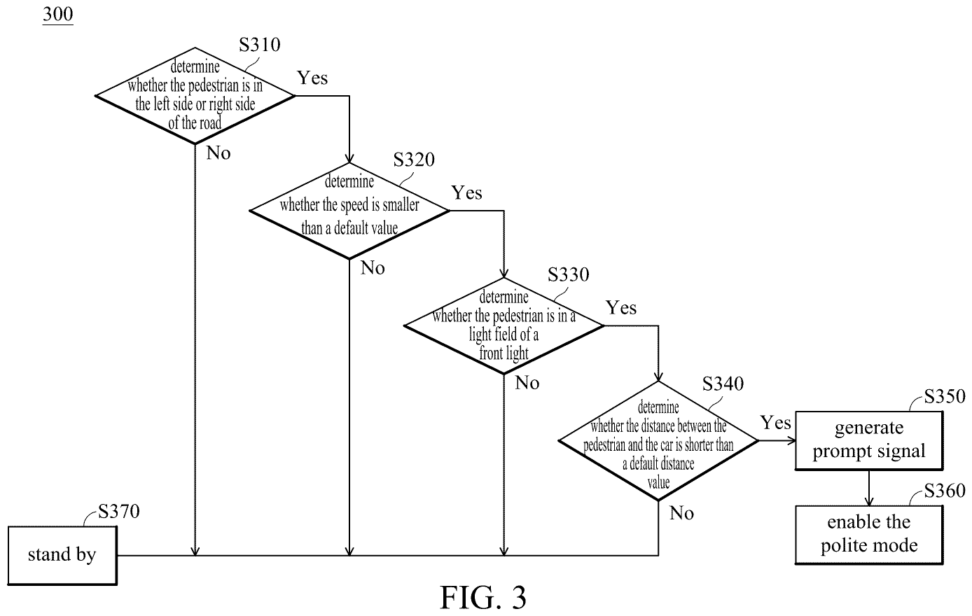

FIG. 3 is a flow chart 300 illustrating an example scenario of determining whether to enter the polite mode according to an embodiment of the invention. The flow chart 300 can be applied to the beam control apparatus 100 configured in a car, and applied to step S240. As shown in FIG. 3, in step S310, when the beam control device 140 of the beam control apparatus 100 determines whether to enter the polite mode, the beam control device 140 may determine whether the pedestrian is in the left side or right side of the road according to the pedestrian information from the ADAS 121.

When the pedestrian is in the left side or right side of the road, step S320 is performed. In step S320, the beam control device 140 may determine whether the speed of the car is slower than the default value according to the speed information of the car. When the pedestrian is not on the left side or right side of the road (i.e., the pedestrian is in the road), step S370 is performed. In step S370, the beam control device 140 may determine not to enter the polite mode.

When the speed of the car is slower than the default value (e.g., 15 km/hour, but the invention should not be limited thereto), step S330 is performed. In step S330, the beam control device 140 may determine whether the pedestrian is in a light field of a front light (e.g., AFS) of the car according to the pedestrian information from the ADAS 121. When the speed of the car is not slower than the default value, step S370 is performed (i.e., the speed of the car has been too fast, it is not suitable to enter the polite mode).

When the pedestrian is in the light field of the front light, step S340 is performed. In step S340, the beam control device 140 may determine whether the distance between the pedestrian and the car is shorter than the default distance value (e.g., shorter than 13 meters, but the invention should not be limited thereto) according to the pedestrian information from the ADAS 121. When the pedestrian is not in the light field of the front light, step S370 is performed. It should be noted that, according to an embodiment of the invention, the default value of the speed of the car and the default distance value between the pedestrian and the car may have a corresponding relationship. For example, when the default distance value between the pedestrian and the car is 4 meters, the default value of the speed may be set to a speed value close to 10 km/hour; when the default distance value between the pedestrian and the car is 8 meters, the default value of the speed may be set to a speed value that is slower than 10 km/hour; and when the default distance value between the pedestrian and the car is 13 meters, the default value of the speed may be set to a speed value that is slower than 13 km/hour, but the invention should not be limited thereto.

When the distance between the pedestrian and the car is shorter than the default distance value, step S350 is performed. In step S350, the beam control device 140 may generate a prompt signal to indicate the driver that the polite mode will be enabled. For example, the processor 120 of the beam control apparatus 100 may generate a prompt sound or display a prompt image according to the prompt signal generated by the beam control device 140 to indicate the driver that the polite mode will be enabled. Then, in step S360, the beam control device 140 may enable the polite mode to control the display pattern of the beam device 150. When the distance between the pedestrian and the car is not shorter than the default distance value, step S370 is performed (i.e., according to the current distance between the pedestrian and the car, the polite mode does not need to be enabled).

It should be noted that the flow chart 300 of FIG. 3 is only used to illustrate the embodiment of the invention, but the invention should not be limited thereto. The order of steps of FIG. 3 also can be adjusted appropriately. For example, the order of enable condition (i.e., steps S310-S340) can be adjusted, or some steps may be selectable (i.e., some steps can be increased or canceled).

In addition, according to an embodiment of the invention, step S310 (i.e., determine whether the pedestrian is in the left side or right side of the road) and step S330 (i.e., determine whether the pedestrian is in a light field of a front light (e.g., AFS) of the car) can be combined to determine whether the pedestrian is in a specific area. The specific area may be defined based on the left boundary, the right boundary, and the longest illumination distance of the front light of the car. FIG. 4 is a schematic diagram of a specific area according to an embodiment of the invention. As shown in FIG. 4, in a frame of image generated by the photographing device 110, the left boundary L may be defined as the left boundary of the car body from the coordinates (x_{L}, h), the right boundary R may be defined as a right boundary of the car body from the coordinates (x_{R}, h), and the longest illumination distance of a front light may be defined as the light field of the AFS (i.e., the area defined by the AFSₘₐₓ and AFSₘᵢₙ), wherein h may refer to the y-axis coordinate of the last pixel point corresponding to the height of the image, and w may refer to the x-axis coordinate of the last pixel point corresponding to the width of the image. The coordinate of the left boundary L may be expressed by y=m_{L}(x−x_{L})+h, and the coordinate of the right boundary R may be expressed by y=m_{R}(x−x_{R})+h, wherein m and m_{R} may refer to the slope of a line parallel the road. The slope may be used to determine the wide angle of the photographing device 110. As shown in FIG. 4, the specific area can be regarded as the intersection of the area outside the left boundary L and right boundary R (i.e., the left side or right side of the road) and the area of the light field of the AFS.

According to an embodiment of the invention, when the beam control device 140 determines whether the pedestrian is in a specific area, the beam control device 140 may know the ROI coordinates corresponding to the pedestrian according to the ROI information of the pedestrian obtained from the ADAS 121. Taking FIG. 5 as an example, the ROI coordinates corresponding to the pedestrian is {(x1, y1), (x2, y2)}. The beam control device 140 may define the coordinates (Px, Py) of the pedestrian as (Px, Py)=((x2-x1)/2, y2). Then, the beam control device 140 may determine whether the pedestrian is in a specific area according to the following formulas.

$$\{ \begin{matrix}the left side of the road , & Py > {m}_{L} ( x - {x}_{L} ) + h \\ the right side of the road , & Py \leq {m}_{R} ( x - x R ) + h \\ on the road , & else\end{matrix} ,$$

$$\{ \begin{matrix}in the light field of the AFS , & {y}_{T} \leq P y < {y}_{B} \\ not in the light field of the AFS , & else\end{matrix}$$

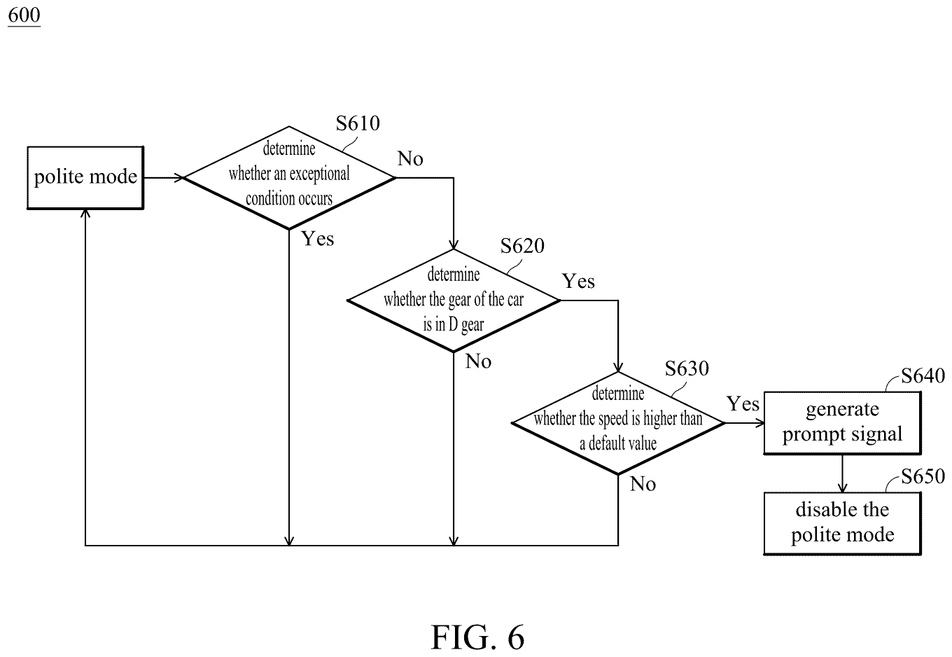

FIG. 6 is a flow chart 600 illustrating an example scenario of determining whether to leave from the polite mode according to an embodiment of the invention. The flow chart 600 can be applied to the beam control apparatus 100 configured in a car. As shown in FIG. 6, when the polite mode is enabled, the beam control device 140 may determine whether to disable the polite mode according to at least one disable condition. In an embodiment, the disable condition may comprise no person is detected in a frame of image, the gear of the car is in D gear and the speed of the car is faster than the default value, and so on.

In step S610, the beam control device 140 may determine whether an exceptional condition occurs (e.g., no person is detected in a frame of image) according to the pedestrian information obtained from the ADAS 121. If the exceptional condition occurs, the beam control device 140 may ignore this frame of image, and perform the operations of polite mode continuously (i.e., perform the operations of polite mode for the next frame of image).

If the exceptional condition does not occur, step S620 is performed. In step S620, the beam control device 140 may determine whether the gear of the car is in D gear according to the information obtained from the ADAS 121. If the gear of the car is not in D gear, the beam control device 140 may perform the operations of polite mode continuously. In an embodiment, the beam control device 140 may determine whether the gear of the car is in D gear and determine whether the car has a speed to determine whether the car is in motion.

If the gear of the car is in D gear, step S630 is performed. In step S630, the beam control device 140 may determine whether the speed of the car is faster than the default value according to the speed information obtained from the ADAS 121. If the speed of the car is not faster than the default value, the beam control device 140 may perform the operations of polite mode continuously.

If the speed of the car is faster than the default value, step S640 is performed. In step S640, the beam control device 140 may generate a prompt signal to indicate the driver that the polite mode will be disabled. For example, the processor 120 of the beam control apparatus 100 may generate a prompt sound or display a prompt image according to the prompt signal generated by the beam control device 140 to indicate the driver that the polite mode will be disabled. Then, in step S650, the beam control device 140 may disable the polite mode.

It should be noted that the flow chart 600 of FIG. 6 is only used to illustrate the embodiment of the invention, but the invention should not be limited thereto. The steps of FIG. 6 also can be adjusted according to different applications.

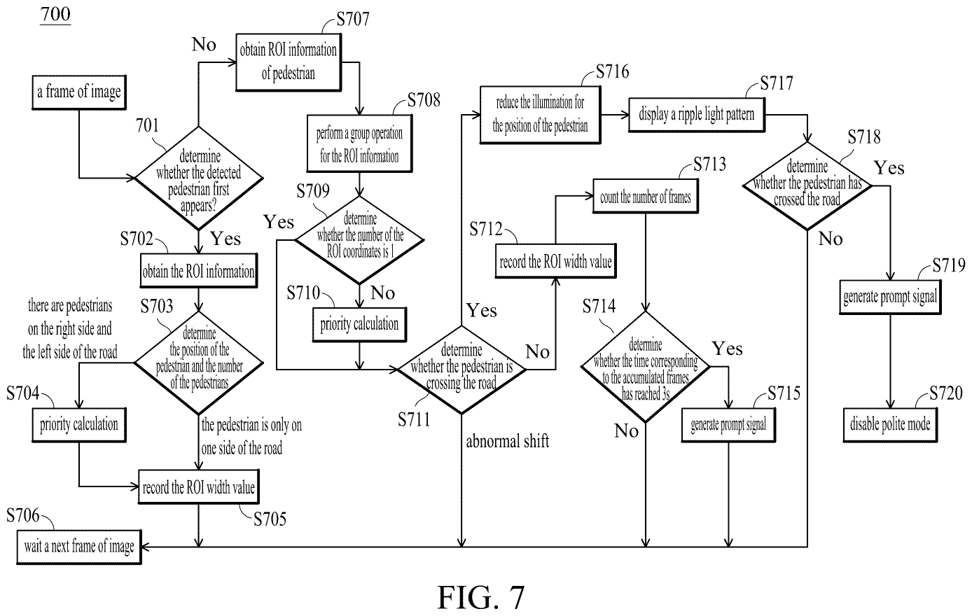

FIG. 7 is a flow chart 700 illustrating an example scenario of the polite mode according to an embodiment of the invention. The flow chart 700 can be applied to the beam control apparatus 100 configured in a car. As shown in FIG. 7, in step S701, in the polite mode, the beam control device 140 may determine whether the detected pedestrian (or pedestrians) first appears according to the pedestrian information corresponding to a frame of image. For example, the beam control device 140 may determine whether the pedestrian number corresponding to a pedestrian first appears according to the pedestrian information corresponding to the pedestrian.

If the pedestrian first appears, step S702 is performed. In step S702, the beam control device 140 may obtain the ROI information corresponding to the pedestrian from the pedestrian information, and record the ROI information corresponding to the pedestrian. Then, in step S703, the beam control device 140 may determine the position of the pedestrian (or pedestrians) and the number of the pedestrians. If there are pedestrians on the right side and the left side of the road, step S704 is performed. In step S704, the beam control device 140 may perform a priority calculation. Specifically, the beam control device 140 may calculate the priority value corresponding to the ROI coordinates corresponding to each pedestrian, and then sort the priority values in order. Then, in step S705, the beam control device 140 may record the ROI width value according to the ROI coordinates corresponding to the pedestrian. If the pedestrian (or pedestrians) is only on one side of the road, step S705 is performed directly. In step S706, the beam control device 140 may wait the pedestrian information corresponding to the next frame of image to perform the operations of the polite mode continuously.

If the pedestrian does not first appear, step S707 is performed. In step S707, the beam control device 140 may obtain the ROI information corresponding to the pedestrian from the pedestrian information. In step S708, the beam control device 140 may perform a group operation for the ROI information according to the pedestrian information of all pedestrians. For example, if the ROI coordinates corresponding to a first pedestrian is {(x₁, y₁), (x₂, y₂)}, and the ROI coordinates corresponding to a second pedestrian is {(x′₁, y′₁), (x′₂, y′₂)}, the beam control device 140 may calculate the intersection over union (IoU) of the ROI coordinates corresponding to the first pedestrian and the ROI coordinates corresponding to the second pedestrian (as shown in following formula).

$$IoU = \frac{max ( min ( {x}_{2} , {x}_{2}^{′} ) - max ( {x}_{1} , {x}_{1}^{′} ) , 0 ) \times max ( min ( {y}_{2} , {y}_{2}^{′} ) - max ( {y}_{1} , {y}_{1}^{′} ) , 0 )}{( {x}_{2} - {x}_{1} ) \times ( {y}_{2} - {y}_{1} ) + ( {x}_{2}^{′} - {x}_{1}^{′} ) \times ( {y}_{2}^{′} - {y}_{1}^{′} )}$$

If the IoU is greater than a set value (e.g., 0.6), the beam control device 140 may group the ROI coordinates corresponding to the first pedestrian and the ROI coordinates corresponding to the second pedestrian according to the ROI coordinates corresponding to the first pedestrian and the ROI coordinates corresponding to the second pedestrian to generate new ROI coordinates ROI′ (as shown in following formula).

$${ROI}^{′} = \{ ( min ( {x}_{1} , {x}_{1}^{′} ) , min ( {y}_{1} , {y}_{1}^{′} ) ) , ( ( max ( {x}_{2} , {x}_{2}^{′} ) , max ( {y}_{2} , {y}_{2}^{′} ) ) \}$$

In step S709, the beam control device 140 may determine whether there is 1 set of ROI coordinates. If there is more than 1 set of ROI coordinates, step S710 is performed. In step S710, the beam control device 140 may perform a priority calculation. Specifically, the beam control device 140 may calculate the priority value corresponding to the ROI coordinates corresponding to each pedestrian, and then sort the priority values in order. For example, referring to FIG. 4 and FIG. 5, the coordinates of each pedestrian may be defined as (Pₓ, P_{y}), and the coordinates of the central point of the bottom of each frame of image may be defined as (w/2, h). Therefore, the beam control device 140 may calculate the priority value corresponding to each set of ROI coordinates according to the following formula, and then sort the calculated priority values in order. The beam control device 140 may perform the operations of polite mode for the pedestrian corresponding to the ROI coordinates with the higher priority value.

$$priority value = \sqrt{{( {P}_{x} - \frac{w}{2} )}^{2} + {( {P}_{y} - h )}^{2}}$$

If there is 1 set of ROI coordinates, the beam control device 140 may perform step S711 directly.

In step S711, the beam control device 140 may determine whether the pedestrian is crossing the road according to the shift value corresponding to the pedestrian. Specifically, the beam control device 140 may determine the shift value of the pedestrian according to the coordinates (e.g., (Pₓ, P_{y})) corresponding to the pedestrian and the coordinates corresponding to the pedestrian in the prior frame of image. For example, the beam control device 140 may calculate the shift value of the pedestrian according to the formula below.

$$shift value = \sqrt{{( {P}_{{x}_{i}} - {P}_{{x}_{i - 1}} )}^{2} + {( {P}_{{y}_{i}} - {P}_{{y}_{i - 1}} )}^{2}} ,$$

The (Pₓ_{ᵢ}, P_{y}_{ᵢ}) may refer to the coordinates corresponding to the pedestrian in the i-th frame of image, and the (Pₓ_{ᵢ₋₁}, P_{y}_{ᵢ₋₁}) may refer to the coordinates corresponding to the pedestrian in the (i−1)-th frame of image. The beam control device 140 may determine whether the pedestrian is crossing the road or determine whether the abnormal shift occurs according to the calculated shift value. For example, the beam control device 140 may determine according to the determination conditions below, but the invention should not be limited thereto. The beam control device 140 may calculate the space resolution (i.e., the ratio of the real distance in the real space and the pixels) according to the calculated shift value (i.e., the pixel value) to obtain the real shift value of the pedestrian (e.g., 1 pixel may be corresponded to n meter), and the beam control device 140 may determine whether the abnormal shift occurs according to the real shift value.

$$\{ \begin{matrix}abnormal shift , & shift value of 2 frames > 100 pixels \\ no ( or not obvious ) shift , & shift value of 2 frames < 20 pixels \\ there is shift , & else\end{matrix}$$

If the beam control device 140 determines that the abnormal shift occurs, the beam control device 140 may ignore the information corresponding to the frame of image, and the flow may back to step S706 to wait the information of the next frame of image.

If the beam control device 140 determines that no (or not obvious) shift occurs, step S712 is performed. In step S712, the beam control device 140 may record the width value (e.g., x₂-x₁) corresponding to the pedestrian according to the ROI coordinates corresponding to the pedestrian. In step S713, the beam control device 140 may count the number of frames. In step S714, the beam control device 140 may determine whether the time corresponding to the accumulated frames has reached a default time (e.g., 3 second). If the time does not reach 3 second, the beam control device 140 may perform step S706 to wait the pedestrian information of the next frame of image. If the time has reached 3 second, step S715 is performed. In step S715, the beam control device 140 may generate a prompt signal. For example, the processor 120 of the beam control apparatus 100 may generate a prompt sound or display a prompt image according to the prompt signal generated by the beam control device 140 to indicate the driver that the pedestrian is not crossing the road (or intersection).

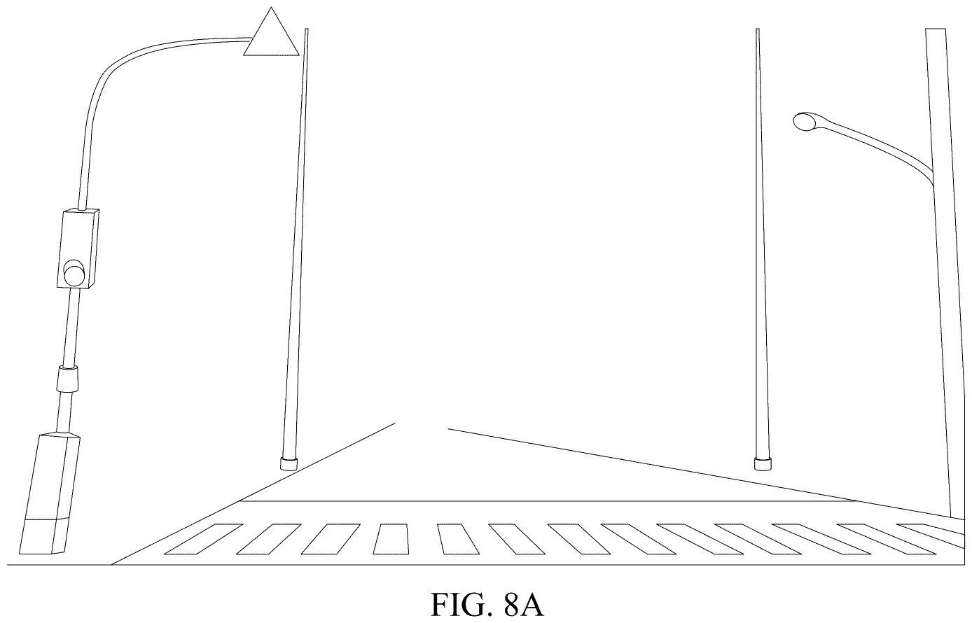

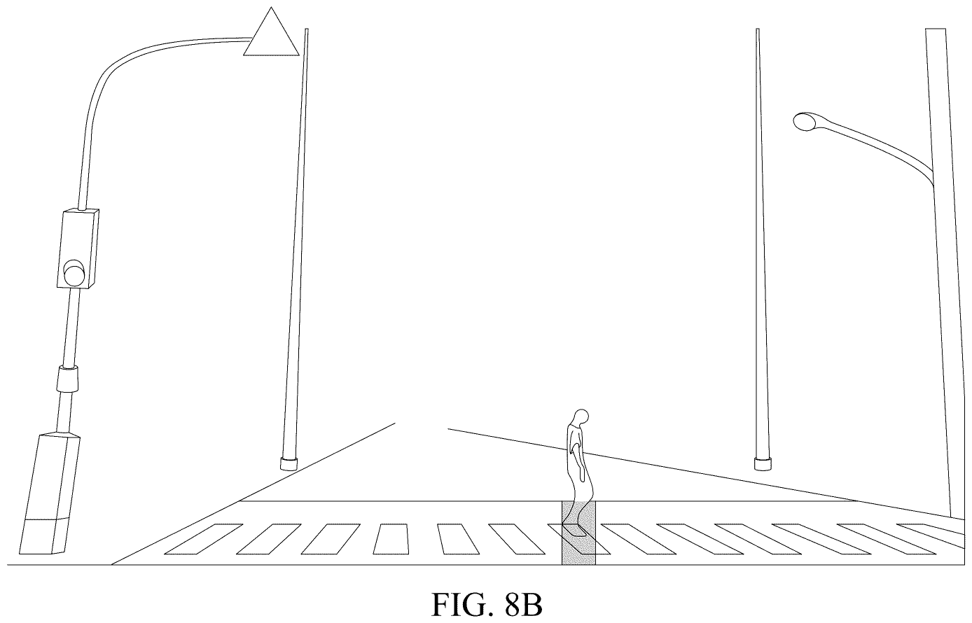

If the beam control device 140 determines that there is a shift corresponding to the pedestrian (the pedestrian is moving), step S716 is performed. In step S716, the beam control device 140 may reduce the illumination for the position of the pedestrian to display a ripple light pattern. In step S717, the beam control device 140 may control the beam device 150 to generate or display the ripple light pattern (as shown in FIGS. 8A-8B).

In step S718, the beam control device 140 may determine whether the pedestrian has crossed the road. If the pedestrian has not crossed the road, the beam control device 140 may perform step S706 to wait the pedestrian information of the next frame of image. If the pedestrian has crossed the road, step S719 is performed. In step S719, the beam control device 140 may generate a prompt signal. For example, the processor 120 of the beam control apparatus 100 may generate a prompt sound or display a prompt image according to the prompt signal generated by the beam control device 140 to indicate the driver that the pedestrian has crossed the road. In step S720, the beam control device 140 may disable the polite mode.

It should be noted that if during the process of the polite mode of FIG. 7, the situation of disabling the polite mode shown in FIG. 6 occurs, the beam control device 140 can early terminate or disable the polite mode.

FIGS. 8A-8B show a schematic diagram of a ripple light pattern according to an embodiment of the invention. As shown in FIG. 8A, the beam control device 140 may control a matrix beam of the beam device 150 to generate the light on the road in the front of the car (e.g., on the zebra crossing). In addition, as shown in FIG. 8B, with the movement of the pedestrian, the beam control device 140 may dynamically control the part of the light-emitting diode (LED) of the matrix beam of the beam device 150 to reduce the illumination for the position of the pedestrian (e.g., the area of under the foot of the pedestrian) to display a ripple light pattern. For example, if the range of the illumination of the LED is 0%-100%, the lowest illumination of the LED may be set to Lₘᵢₙ=40%, and the highest illumination of the LED may be set to Lₘₐₓ=100%, but the invention should not be limited thereto. The beam control device 140 may control the illumination of the LEDs in different blocks of the matrix beam of the beam device 150 according to the lowest illumination Lₘᵢₙ and the highest illumination Lₘₐₓ.

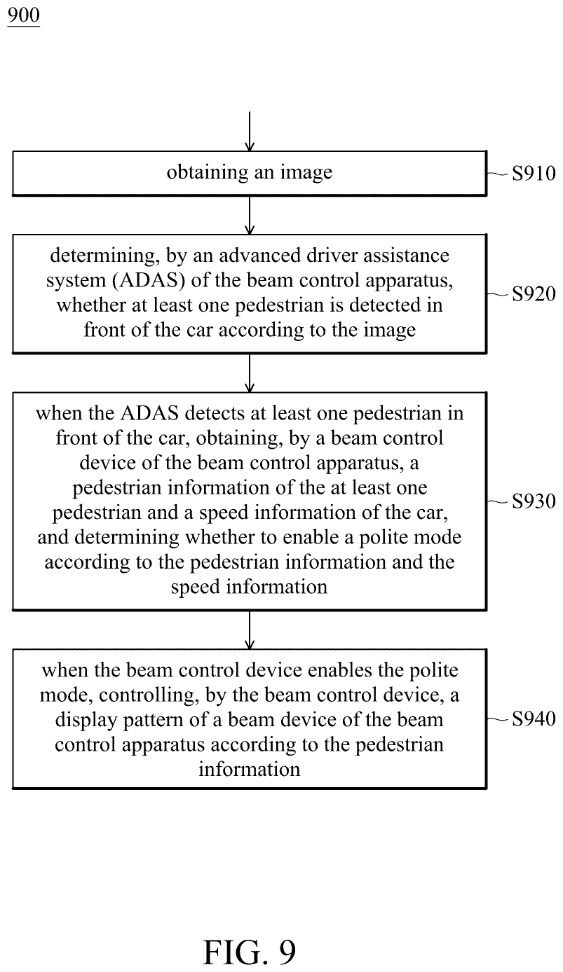

FIG. 9 is a flow chart 900 illustrating a beam control method according to an embodiment of the invention. The beam control method can be applied to the beam control apparatus 100 which is configured in a car. As shown in FIG. 9 in step S910, the beam control apparatus 100 may obtain an image.

In step S920, the ADAS 121 of the beam control apparatus 100 may determine, based on the obtained image, whether at least one pedestrian is detected in a specific area.

In step S930, when the ADAS 121 detects at least one pedestrian in the specific area, the beam control device 140 of the beam control apparatus 100 may obtain the pedestrian information of the detected pedestrian and the speed information of the car from the ADAS 121, and determine whether to enable a polite mode according to the pedestrian information and the speed information.

In step S940, when the beam control device 140 enables the polite mode, the beam control device 140 may control the display pattern of the beam device 150 of the beam control apparatus 100.

According to an embodiment of the invention, in the beam control method, the beam device 150 may comprise a matrix beam. When the beam control device 140 enables the polite mode, according to the pedestrian information, the beam control device 140 may control the matrix beam to display a ripple light pattern.

According to an embodiment of the invention, in the beam control method, the pedestrian information may comprise an ROI information corresponding to each pedestrian.

According to an embodiment of the invention, in the beam control method, in the polite mode, the beam control device 140 of the beam control apparatus 100 may perform a priority value sorting according to the ROI information corresponding to each pedestrian.

According to an embodiment of the invention, in the beam control method, the beam control device 140 of the beam control apparatus 100 may determine whether an enable condition is met according to the pedestrian information and the speed information. When the enable condition is met, the beam control device 140 of the beam control apparatus 100 may enable the polite mode.

According to an embodiment of the invention, in the beam control method, the enable condition may comprise that at least one pedestrian is in the specific area, the speed of the car is slower than the default value, and the distance between the car and the pedestrian is shorter than the default distance value.

According to an embodiment of the invention, in the beam control method, the specific area may be defined based on the left boundary, the right boundary, and the longest illumination distance of the front light of the car.

According to an embodiment of the invention, in the beam control method, the beam control device 140 of the beam control apparatus 100 may determine whether to disable the polite mode according to a disable condition.

According to an embodiment of the invention, in the beam control method, the disable condition may comprise no person is detected in at least one frame of image, the gear of the car is in D gear and the speed of the car is faster than the default value.

According to an embodiment of the invention, in the beam control method, the beam device 150 may comprise a plurality of beams. Each beam may comprise a low beam, a high beam, or a matrix beam.

According to the beam control method provided in the invention, when the pedestrian will cross the road, the method may make the driver quickly be aware of the pedestrian by controlling the display patten of the beam of the car. In addition, the beam control method may increase pedestrians' awareness of the car actions, thereby further enhancing traffic safety.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A beam control method, applied to a beam control apparatus configured in a car, comprising:
obtaining, by the beam control apparatus, an image;
determining, by an advanced driver assistance system (ADAS) of the beam control apparatus, whether at least one pedestrian is detected in front of the car according to the image;
when the ADAS detects at least one pedestrian in front of the car, obtaining, by a beam control device of the beam control apparatus, a pedestrian information of the at least one pedestrian and a speed information of the car, and determining whether to enable a polite mode according to the pedestrian information and the speed information; and
when the beam control device enables the polite mode, controlling, by the beam control device, a display pattern of a beam device of the beam control apparatus according to the pedestrian information.

2. The beam control method of claim 1, wherein the beam device comprises a matrix beam, and the data processing method further comprises:
when the beam control device enables the polite mode, according to the pedestrian information, controlling, by the beam control device, the matrix beam to display a ripple light pattern.

3. The beam control method of claim 1, wherein the pedestrian information comprises a region of interest (ROI) information corresponding to each pedestrian.

4. The beam control method of claim 3, further comprising:
in the polite mode, performing, by the beam control device, a priority value sorting according to the ROI information corresponding to each pedestrian.

5. The beam control method of claim 1, wherein the determining whether to enable the polite mode comprises:
determining, by the beam control device, whether an enable condition is met according to the pedestrian information and the speed information; and
when the enable condition is met, enabling, by the beam control device, the polite mode.

6. The beam control method of claim 1, wherein the enable condition comprises that at least one pedestrian is in the specific area, a speed of the car is slower than a default value, and a distance between the car and the at least one pedestrian is shorter than a default distance value.

7. The beam control method of claim 6, wherein the specific area is defined based on a left boundary, a right boundary and a longest illumination distance of a front light of the car.

8. The beam control method of claim 1, further comprising:
determining, by the beam control device, whether to disable the polite mode according to a disable condition.

9. The beam control method of claim 8, wherein the disable condition comprises that no person is detected in at least one frame of image, a gear of the car is in D gear and a speed of the car is faster than a default value.

10. The beam control method of claim 9, wherein the beam device comprises a plurality of beams, and each beam comprises a low beam, a high beam, or a matrix beam.

11. A beam control apparatus, configured in a car, comprising:
a photographing device, obtaining an image;
an advanced driver assistance system (ADAS), determining whether at least one pedestrian is detected in front of the car according to the image;
a beam control device, obtaining a pedestrian information of the at least one pedestrian and a speed information of the car when the ADAS detects at least one pedestrian in front of the car, and determining whether to enable a polite mode according to the pedestrian information and the speed information; and
a beam device, coupled to the beam control device, wherein when the beam control device enables the polite mode, the beam control device controls a display pattern of the beam device according to the pedestrian information.

12. The beam control apparatus of claim 11, wherein when the beam control device enables the polite mode, according to the pedestrian information, the beam control device controls the matrix beam to display a ripple light pattern.

13. The beam control apparatus of claim 11, wherein the pedestrian information comprises a region of interest (ROI) information corresponding to each pedestrian.

14. The beam control apparatus of claim 13, wherein in the polite mode, the beam control device performs a priority value sorting according to the ROI information corresponding to each pedestrian.

15. The beam control apparatus of claim 11, wherein the beam control device determines whether an enable condition is met according to the pedestrian information and the speed information, and when the enable condition is met, the beam control device enables the polite mode.

16. The beam control apparatus of claim 11, wherein the enable condition comprises that at least one pedestrian is in the specific area, a speed of the car is slower than a default value, and a distance between the car and the at least one pedestrian is shorter than a default distance value.

17. The beam control apparatus of claim 16, wherein the specific area is defined based on a left boundary, a right boundary and a longest illumination distance of a front light of the car.

18. The beam control apparatus of claim 11, wherein the beam control device determines whether to disable the polite mode according to a disable condition.

19. The beam control apparatus of claim 18, wherein the disable condition comprises that no person is detected in at least one frame of image, a gear of the car is in D gear and a speed of the car is faster than a default value.

20. The beam control apparatus of claim 19, wherein the beam device comprises a plurality of beams, and each beam comprises a low beam, a high beam, or a matrix beam.
